(19) United States
(12) Patent Application Publication
(10) Pub. No.: US 2012/0019489 A1
(43) Pub. Date: Jan. 26, 2012

(54) Method of Timing Control for a Display Panel

(75) Inventors: Yuan-Yi LIAO, Banqiao City, Taipei County (TW); Sheh-Cha Cho, Tainan City (TW)

(73) Assignee: CHUNGHWA PICTURE TUBES, LTD., Bade City (TW)

(21) Appl. No.: 12/901,554

(22) Filed: Oct. 10, 2010

(30) Foreign Application Priority Data
Jul. 20, 2010 (TW) 099123877

(51) Int. Cl. G09G 5/00

(52) U.S. Cl. 345/204

(57) ABSTRACT

The present invention discloses a method of timing control for a display panel, the method comprises steps of employing a timing corrector to set a value of timing diversity; and using the timing corrector to modify the gate timing signals with identical timing to act as odd gate timing signals and even gate timing signals, and transferring the odd gate timing signals and the even gate timing signals to odd gate lines and even gate lines respectively, thereby activating the charging process, wherein the charging timing of the odd gate lines based on the odd gate timing signals is longer than the charging timing of even gate lines based on the even gate timing signals. Accordingly, the problem caused by vertical lines of the display panel can be solved.

### TECHNICAL FIELD

The present invention generally relates to a method for eliminating vertical line image of a dual-gate display panel, especially to the timing control method for a dual-gate display panel, whereby eliminating vertical line image of the dual-gate display panel.

### DESCRIPTION OF THE RELATED ART

Because LCD (Liquid Crystal Display) has advantages of low power consumption, light weight, high resolution, high color saturation, and longevity, it has been widely applied on electronic products such as the computer display and TV in place of conventional CRT to play the role of the main technology of the display.

Generally, the pixel of LCD is composed of three sub pixels including R, G, and B, and each sub pixel is driven by a gate driver and a source driver. Specifically, each sub pixel has a pixel transistor, wherein a TFT (Thin Film Transistor) is a preferred candidate. The gate electrode of the pixel transistor is connected to the gate line controlled by the gate driver; and the source electrode is connected to the data line controlled by the source driver; and the drain electrode is connected to the sub pixel. Each sub pixel mentioned above includes a common electrode which is applied with Vcom (voltage of common electrode). The gate driver applies voltage on gate lines in specific order to activate all of the rows of pixel transistors on the gate line, and the gate driver applies voltage on gate lines by line to line scanning order, while the source driver applies voltage on data lines. The drain electrode of the pixel transistor which has been activated applies bias on the liquid crystal material of the sub pixel according to the voltage of the source electrode provided by the data line, so as to control color and luminosity of the sub pixel. Further, the voltage difference between the voltage provided by the drain electrode of the pixel transistor and Vcom of the common electrode is typically sensed by the liquid crystal material. The electric field raised by the voltage difference can drive liquid crystal molecular to incline with an angle, whereby determining the intensity that the backlight passes through the sub pixel. However, the liquid crystal will become dull if it maintains the fixed angle in a long period, thus, the molecular must be reversed regularly to prolong life of LCD. Typically, the polarity reversal of Vcom can be introduced to achieve the reversal of molecular.

In a structure of a general LCD, pixel transistors on the same row are connected to different data lines, namely, one data line can provides voltage to a column of pixel transistor on the data line. However, in pace with development of industry, the dimension of the LCD panel becomes greater, and the required resolution must be improved correspondingly, and the quantities of gate lines and data lines will increase correspondingly, thus, the manufacturing cost will also increase. To lower cost, a dual-gate LCD panel is introduced, the characteristic of aforementioned dual-gate LCD panel is that one data line can provide voltage to two columns of pixel transistors on either sides of the data line. Therefore, quantities of pixel transistors which the data line of the dual-gate LCD can provide are double over the quantities of pixel transistors which the data line of the conventional LCD can provide. Thus, if the quantities of pixels are identical, quantities of data lines in a dual-gate LCD are half of quantities of data lines in a conventional LCD, such that the cost of material and manufacture can be lowered. For example, as shown in FIG. 1, the sub pixel 101 and 102 on the same row are connected to the identical data line S1, and the sub pixel 103 and 104 are connected to another data line S2, thus, if there are ten sub pixels on any row, only five data lines need to be provided; if there are 500 sub pixels on any row, only 250 data lines are needed to be provided. Accordingly, quantities of data lines in a dual-gate LCD are half of the quantities of data lines in a conventional LCD.

In the dual-gate LCD, the charging time of adjacent sub pixels on the same row is identical. Referred to FIG. 1 and FIG. 2, in the time interval 201 that V_{COM} is at high level of V_{COMH}, the gate line G1 is conducted first, and the gate line G2 is conducted by the data line S1 subsequently. The conducting time interval 203 of the gate line G1 (which means the charging time interval of the sub pixel 101) and the conducting time interval 204 of the gate line G2 which means the charging time interval of the sub pixel 102 is identical. Similarly, in the time period 202 that V_{COM} is at low level V_{COML}, the conducting time interval 205 of the gate line G3 (which means the charging time interval of the sub pixel 105) and the conducting time interval 206 of the gate line G4 (which means the charging time interval of the sub pixel 106) is also identical. Thus, the charging time of the sub pixel 101 charged by the gate line G1 and the charging time of the sub pixel 102 are identical. Similarly, the charging time of the sub pixel 105 is also the same as the charging time of the sub pixel 106.

However, The initial voltage of one sub pixel is different from the one of the sub pixel adjacent to aforementioned sub pixel which is connected to the same data line because the one gate line is conducted earlier and another gate line is conducted later, such that the sub pixel charged earlier fails to be charged to the target voltage, thereby causing voltage difference between adjacent sub pixels, and further generating vertical lines image on the frame of the display. Specifically, equivalent capacitance is raised by the layout on the data line, and when the data line charges the sub pixel which is charged earlier, it has to charge the equivalent capacitance on the data line first, and then charges the sub pixel later, and nevertheless the data line just needs to charge the sub pixel which is charged later because the equivalent capacitance in the data line has been charged already, thereby causing voltage difference between two adjacent sub pixels. Referred to FIG. 1 and FIG. 3, when the gate line G1 is conducted, the data line S1 charges the sub pixel 101. The relation between voltage and time is shown as the curve 301. When the charge of the sub pixel 101 is ceased, the gate line G2 is then conducted, and the sub pixel 102 is charged by the data line S1, and the relation between voltage and time is shown as the curve 302, which is almost a steadily horizontal line. Based on aforementioned description, it can be acknowledged that the voltage of the sub pixel 101 is still not stable to target voltage, however the sub pixel 102 is steadily charged to the target voltage, therefore, it will cause the phenomena of voltage difference between the sub pixel 101 and 102, thereby generating a vertical line image and lowering quality of the frame of the display.

However, the charging time of adjacent sub pixels can just be increased or decreased simultaneously in conventional dual-gate LCD, and the charging time of single sub pixel cannot be altered independently, thus, vertical line image cannot be prevented.

Based on aforementioned description, there are some difficulties and shortcomings existing in the technology of dual-gate LCD to be overcome.

### SUMMARY OF THE INVENTION

To overcome aforementioned shortcomings and difficulties, the present invention provides a timing control method for a dual-gate display.

One purpose of the present invention is to enable all adjacent sub pixels connected to the same data line on the same row to be charged to target voltage, thereby solving the problem of vertical line image of the dual-gate display.

Another purpose of the present invention is to improve quality of the frame of the display without modifying the structure of the dual-gate display.

To achieve aforementioned purposes, the present invention provides a timing control method for a dual-gate TFT, which comprises: generating two gate timing signals with identical timing by a timing controller; setting a timing variance by a timing modifier, wherein the timing variance may be percentage, such as 1%, 2%, or 5%, etc, or may be time interval, such as 3 μs, 5 μs, or 10 μs, etc; modifying the two gate timing signals with identical timing to a first gate timing signal and a second gate timing signal according to the timing variance and transferring to a gate driver by the timing modifier; transmitting the first gate timing signal to a first gate line and the second gate timing signal to a second gate line by the gate driver; and activating a charging process of a first sub pixel according to the first gate timing signal by the first gate line and a charging process of a second sub pixel according to the second gate timing signal by the second gate line; wherein the first gate timing signal is defined by a first gate charging timing and the second gate timing signal is defined by a second gate charging timing, and the first gate charging timing is greater than the second gate charging timing.

By aforementioned method, the charging time of the first sub pixel can be greater than the charging time of the second sub pixel, therefore, the first sub pixel can be charged to the target voltage in longer and enough time, thereby reducing the voltage difference between the first sub pixel and the second sub pixel, so as to solve the problem of vertical lines.

The present invention further provides a timing control method for a dual-gate display, which comprises: generating a plurality of gate timing signals with identical timing by a timing controller; setting a timing variance by a timing modifier, wherein the timing variance may be percentage, such as 1%, 2%, or 5%, etc, or may be a time interval, such as 3 μs, 5 μs, or 10 μs, etc; modifying the plurality of gate timing signals with identical timing to a plurality of odd gate timing signals and a plurality of even gate timing signals according to the timing variance and transferring to at least a gate driver by the timing modifier; transmitting the plurality odd gate timing signals to a plurality of odd gate lines and the plurality of even gate timing signals to a plurality of even gate lines by the at least a gate driver; and activating a charging process of a plurality of odd sub pixels according to the plurality of odd gate timing signals by the plurality of odd gate lines and a charging process of a plurality of even sub pixels according to the plurality of even gate timing signals by the plurality of even gate lines; wherein the plurality of odd gate timing signals are defined by an odd gate charging timing and the plurality of even gate timing signals are defined by an even gate charging timing, and the odd gate charging timing is greater than the even gate charging timing.

By aforementioned method, the charging time of odd sub pixels can be greater than the charging time of even sub pixels, therefore, odd sub pixels can be charged to target voltage in longer or enough time, so the voltage differences between odd sub pixels and even sub pixels can be reduced, and the luminosity difference on the frame can be reduced either, such that problems of vertical lines can be solved.

The above-mentioned description is to illustrate purposes of the present invention, technical characteristics to achieve the purposes, and the advantages brought from the technical characteristics, and so on. And the present invention can be further understood by the following description of the preferred embodiment accompanying with the drawings and the claims.

### BRIEF DESCRIPTION OF THE DRAWINGS

FIG. 1 shows a conventional dual-gate display.

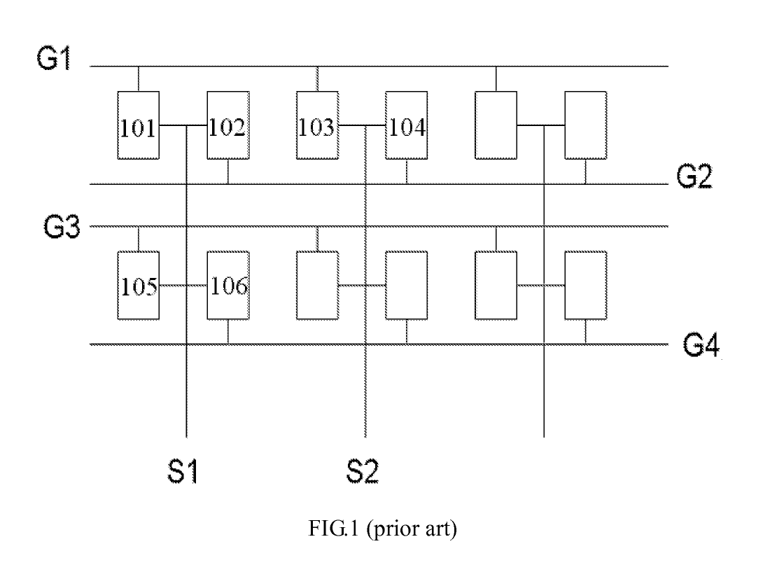

FIG. 2 shows the charging timing of the conventional dual gate display.

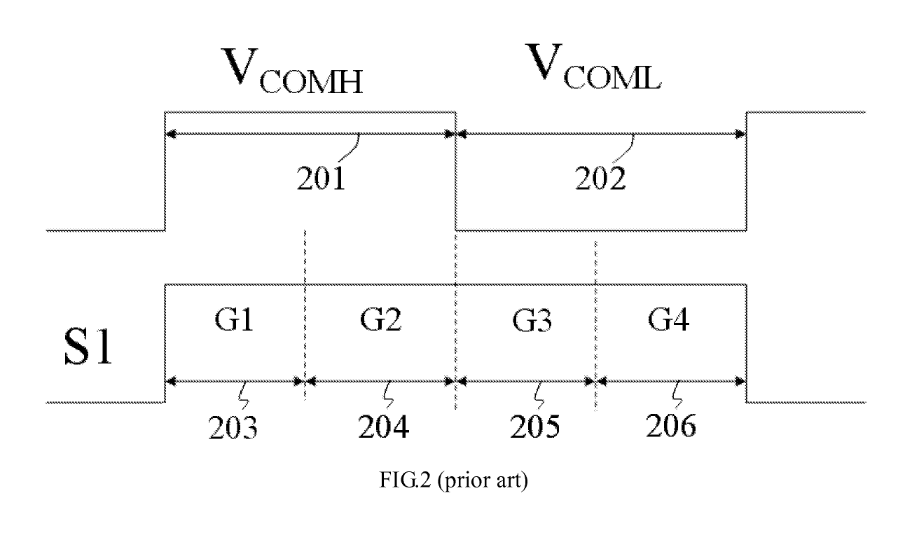

FIG. 3 shows the relation that voltage relates to time of the sub pixel of the dual-gate display.

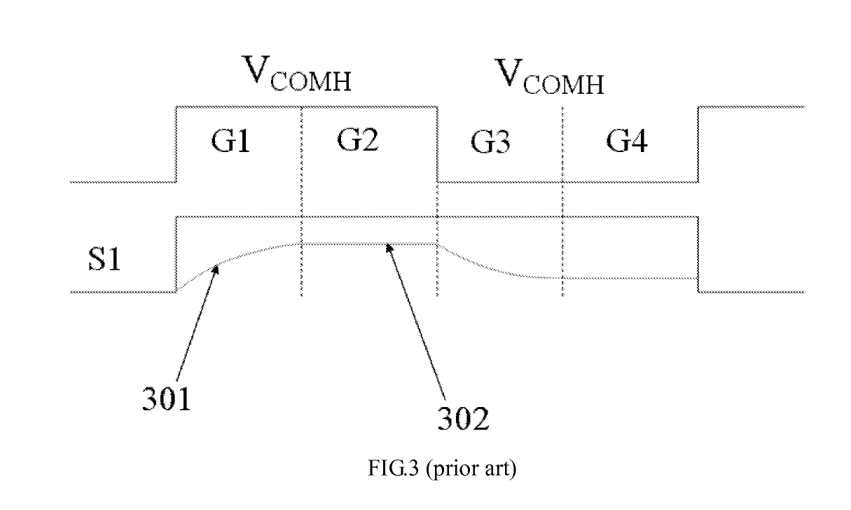

FIG. 4 shows the steps diagram of the present invention.

FIG. 5 shows a specific embodiment of the present invention.

FIG. 6 shows the charging timing of the present invention.

FIG. 7 shows an embodiment of setting the timing variance.

FIG. 8 shows the circuit diagram of the embodiment of the present invention.

### DETAILED DESCRIPTION

The present invention will be described in the following embodiments and perspective, which is introduced to illustrate the structures and steps of the present invention, and is just adopted to exemplify the present invention rather than limiting it. Therefore, in addition to the preferred embodiments in the specification, the present invention can also be widely applied to other embodiments.

Details of the present invention are to be described, which comprise the embodiments of the present invention. Referred to the drawings and the following description, the similar symbols are introduced to recognize identical or functionally similar elements, and the greatly simplified drawings are anticipated to illustrate the main characteristics of the embodiments. Further, not every characteristic are concretely described in the drawings, and the elements in the drawings are all depicted in a relative measurement instead of being sketched according to scale.

The present invention discloses a timing control method for a dual-gate display, which can reduce the voltage difference between adjacent sub pixels by means of setting a timing variance to modify the charging time of adjacent sub pixels on the same row in the display, thereby solving the problem of vertical line image issue caused by the voltage difference between adjacent sub pixels. Aforementioned display includes, but is not limited to, a LCD, a PDP (Plasma Display Panel), a FED (Field Emission Display), a OLED (Organic Light Emitting Diode) display, and so on.

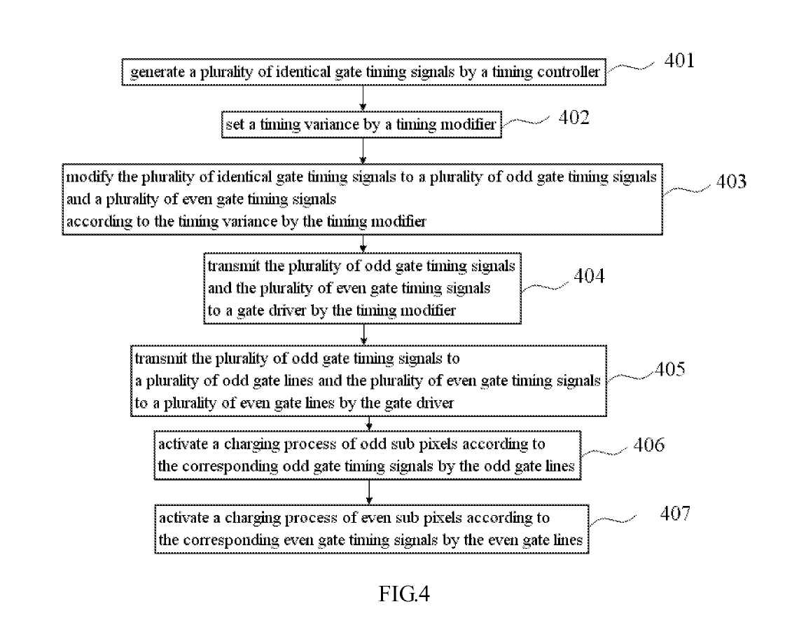

Referred to FIG. 4, which illustrates the preferred embodiment of the present invention, it discloses a timing control method for a dual-gate display. First, in the step 401, a plurality of identical gate timing signals is generated by a timing controller. Specifically, aforementioned timing controller is a control IC which can generate gate timing signals with identical timing. Aforementioned timing is average gate timing which is half of the time interval of reversal polarity of V_{COM}. In other words, if the pixel transistor is controlled by the gate timing signal, the charging time of adjacent sub pixels is identical. And then, in the step 402, a timing variance is set by a timing modifier.

In some embodiments, the timing variance may be percentage, such as 1%, 2%, or 5%, etc. In some embodiments, the timing variance may be a time interval, such as 3 μs, 5 μs, 10 μs, etc. The type of timing variance can be determined according to the algorithm of the timing modifier, and the value of timing variance depends on distinctness of vertical lines. When luminosity difference on the frame is greater, namely, vertical line image is more obvious, the required timing variance is greater. Contrarily, when the luminosity difference on the frame is less, namely, vertical line image is less obvious, the required timing variance is less. And then, in the step 403, the plurality of identical gate timing signals is modified to a plurality of odd gate timing signals and a plurality of even gate timing signals according to the timing variance by the timing modifier, wherein aforementioned odd gate timing signals are defined by an odd gate timing and the even timing signals are defined by an even gate timing, and the odd gate timing is greater than the even gate timing.

More specifically, the odd gate timing is aforementioned average gate timing added by the timing variance, and the even gate timing is the average gate timing minus the timing variance. Subsequently, in the step 404, the plurality of odd gate timing signals and the plurality of even gate timing signals are transmitted to a gate driver by aforementioned timing modifier. And then, in the step 405, the plurality of odd gate timing signals is transmitted to a plurality of odd gate lines and the plurality of even gate timing signals to a plurality of even gate lines by the gate driver. And then, in the step 406, the odd gate lines are conducted according to the corresponding odd gate timing signals to charge the odd sub pixels coupled to aforementioned odd gate lines. Finally, in the step 407, the even gate lines are conducted according to the even gate timing signals to charge the even sub pixels coupled to aforementioned even gate lines.

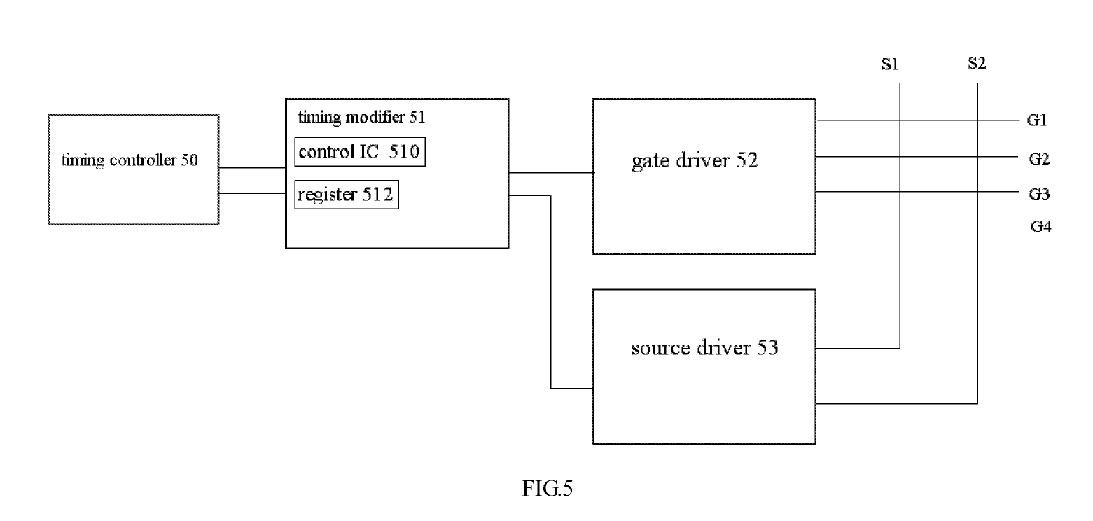

Referred to FIG. 5, FIG. 5 illustrates a specific embodiment of the present invention. In the embodiment, four gate lines and two data lines will be introduced as an example, however, those skilled persons in the art should understand that the number of gate lines and data lines in the embodiment is illustrated for example rather than limiting the present invention. The embodiment includes a timing controller 50, a timing modifier 51, a gate driver 52, and a source driver 53, wherein the gate driver 52 and the source driver 53 are coupled to the timing modifier 51 respectively, and the timing modifier is coupled to the timing controller 50.

In the embodiment, the timing controller 50 can generate four identical gate timing signals and two source timing signals and can transfer aforementioned signals to the timing modifier 51. It should be noticed that aforementioned “identical” means the conducting time intervals are the same. Specifically, the conducting time interval is half of the time interval of reversal polarity of V_{COM}. The timing modifier 51 may include a control IC 510 and a register 520, wherein, appropriate timing variance which may be percentage, such as 1%, 2%, 5%, or x %, etc, can be set in the register 520 by the user. And the gate timing signals can be modified to be a first gate timing signal, a second gate timing signal, a third gate timing signal, and a fourth gate timing signal according to aforementioned timing variance by the control IC 510, and aforementioned modified signals will be transferred to the gate driver 52.

The source timing signals will not be modified in the timing modifier 51 and will be transferred to the source driver 53 directly. The gate driver 52 is coupled to a first gate line G1, a second gate line G2, a third gate line G3 and a fourth gate line G4, and can transmit the first gate timing signal to the first gate line G1, the second gate timing signal to the second gate line G2, the third gate timing signal to the third gate line G3, and the fourth gate timing signal to the fourth gate line G4. And the source driver 53 is coupled to data lines S1 and S2 and transmits the source timing signals to the data lines S1 and S2 respectively.

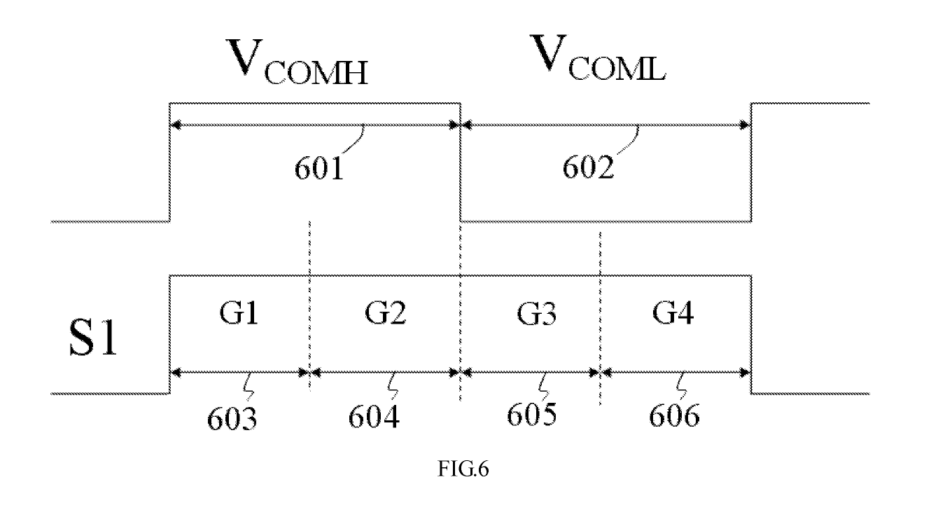

Referred to FIG. 6, FIG. 6 shows the timing control disclosed in the present invention, and the timing control method can be further understood in the figure accompanied with FIG. 5. In the embodiment, the timing variance is a percentage value, and the conducting time interval 603 of the first gate line G1 is the time interval of V_{COMH} 601 times the percentage of (50% plus the time variance), such as: time interval 601×51%, time interval 601×52%, time interval 601×55%, or time interval 601×(50+x) %, and so on. And the conducting time interval 604 of the second gate line G2 is the time interval of V_{COMH} 601 times the percentage of (50% minus the timing variance), such as: time interval 601×49%, time interval 601×48%, time interval 601×45%, or time interval 601×(50−x) %, and so on. On the other hand, the conducting time interval of the third gate line G3 is the time interval of V_{COML} 602 times the percentage of (50% plus the timing variance), such as time interval 602×51%, time interval 602×52%, time interval 602×55%, or time interval 602×(50+x) %, and so on. The conducting time interval of the fourth gate line G4 is the time interval of V_{COML} 602 times the percentage of (50% minus the timing variance), such as time interval 602×49%, time interval 602×48%, time interval 602×45%, or time interval 602×(50−x) %, and so on.

It should be noticed that no matter what the time variance is, the summation of time interval 603 and time interval 604 equals to the time interval 601, similarly, the summation of time interval 605 and time interval 606 equals the time interval 602. In other words, no matter what value the timing variance is, the time interval of reversal polarity of V_{COM} will not be affected. Consequently, the charging time of adjacent sub pixels can be modified respectively without affecting the time interval of reversal polarity V_{COM}, whereby solving the problem of vertical line image issue.

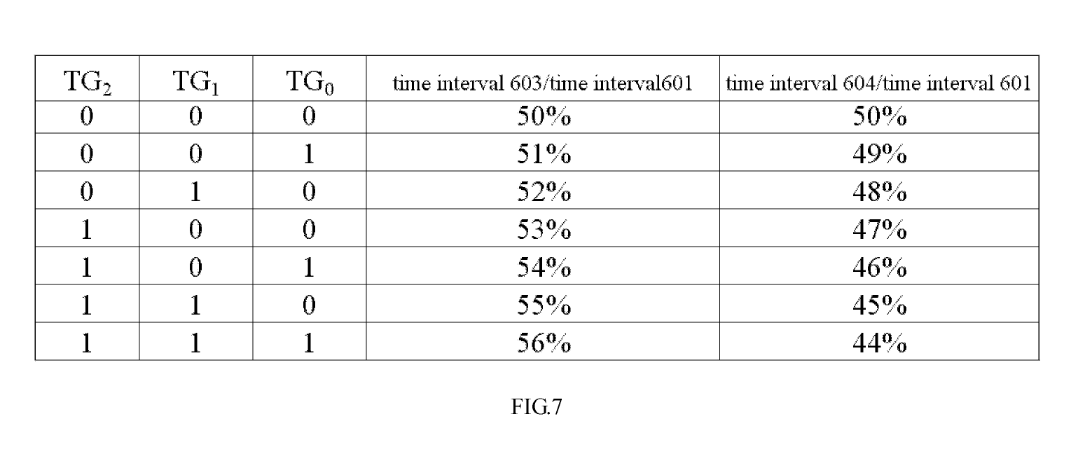

Referred to FIG. 7, which shows an embodiment of setting the timing variance, it is a diagram that the input parameter of a register relates to required timing variance. The register introduced in the embodiment is a 3-bits register which includes three parameters TG₀, TG₁, and TG₂, and each parameter can be set as 0, or 1. Thus, there will be eight different situations, wherein seven situations are chosen as examples, which are described as follows: when TG₂=0, TG₁=0, TG₀=0, time interval 603/time interval 601 is 50% and time interval 604/time interval 601 is 50%; when TG₂=0, TG₁=0, TG₀=1, time interval 603/time interval 601 is 51% and time interval 604/time interval 601 is 49%; when TG₂=0, TG₁=1, TG₀=0, time interval 603/time interval 601 is 52% and time interval 604/time interval 601 is 48%; when TG₂=1, TG₁=0, TG₀=0, time interval 603/time interval 601 is 53% and time interval 604/time interval 601 is 47%; when TG₂=1, TG₁=0, TG₀=1, time interval 603/time interval 601 is 54% and time interval 604/time interval 601 is 46%; when TG₂=1, TG₁=1, TG₀=0, time interval 603/time interval 601 is 55% and time interval 604/time interval 601 is 45%; when TG₂=1, TG₁=1, TG₀=1, time interval 603/time interval 601 is 56% and time interval 604/time interval 601 is 44%.

Consequently, the appropriate timing variance can be chosen through the register 512 by the user, such that the gate timing signals transmitted from the timing modifier 50 can be modified. However, those skilled persons in the art should understand that the register 512 introduced in the embodiment may be different kinds of registers and may also includes more or less bits, and the relation between the parameters and the time variance may includes various combinations. Thus, the embodiment is just to illustrate rather than limiting the present invention.

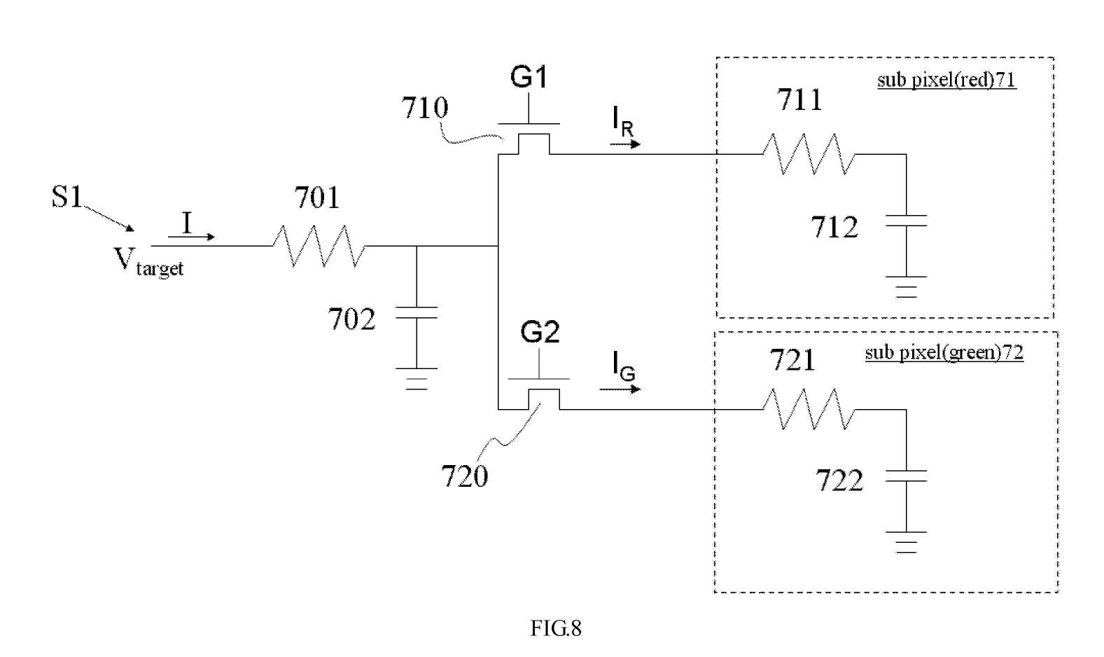

The determination of the timing variance is described as follows. Referred to FIG. 8, which is a circuit diagram including two adjacent sub pixels on the same row, the red sub pixel 71 includes a first resistance 711 and a first capacitance (R_{C}) 712, which are connected in series and coupled to the first transistor 710 controlled by a gate line G1, in which a TFT is preferable. The green sub pixel 72 comprises a second resistance 721 and a second capacitance (G_{C}) 722, which are connected in series and coupled to the second transistor 720 controlled by another gate line G2, in which a TFT is preferable.

Additionally, the first transistor 710 and the second transistor 720 are connected in parallel and coupled to the data line S1 which includes a source resistance 701 and a source capacitance (S_{C}) 702, wherein the source capacitance 702 is an equivalence capacitance raised by the interlaced layout in the display. When the gate line G1 is conducted, the first transistor 710 will be turned on, such that the series circuit connected by the first transistor 710, the first resistance 711, and the first capacitance 712 will be conducted. At this moment, the red sub pixel 71 will be charged by the current I in the data line S1, and is expected to be charged to target voltage V_{target}. However, in addition to the first capacitance 712, the source capacitance 702 also has to be charged by the data line S1; when the gate line G1 stops being conducted and the gate line G2 is conducted, the data line S1 just has to charge the second capacitance 722 without charging the source capacitance 702 because the source capacitance has been charged enough. Thus, if the charging time interval of the first capacitance 712 is the same as the charging time interval of the second capacitance 722, the electric quantities obtained by the first capacitance 712 must be less than the electric quantities obtained by the second capacitance 722.

Accordingly, a timing variance is required to make the conducting time interval of the gate line G1 greater than the conducting time interval of the gate line G2, thereby enabling the first capacitance 712 to be charged to V_{target} in enough time. FIG. 6 can be referred hereinafter, wherein the conducting time interval of the gate line G1 is the time interval 603 and the conducting time interval of the gate line G2 is the time interval 604. Because the specification of each sub pixel in the LCD is identical, the first capacitance 712 is the same as the second capacitance 722, and the first resistance 711 is the same as the second resistance 721. Therefore, current I_{R} and I_{G} is identical, such that the timing variance just depends on the source capacitance 702. If the source capacitance 702 is the first capacitance 712 times 0.09, namely, S_{C}=0.09R_{C}, the time interval 603: time interval 604=S_{C}+R_{C}:G_{C}=1.09:1=52%:48%. The appropriate timing variance can be obtained from aforementioned percentage, and in accompany with reference of FIG. 7, the parameters can be set as TG₂=0, TG₁=1, TG₀=0 in the register, such that the timing variance can be determined.

Based on aforementioned description, the timing variance can be determined adequately by calculating or measuring value of the source capacitance 702. However, No matter by means of calculating or measuring, it's very difficult to obtain value of the source capacitance 702 because the layout of the display is very complex. Thus, the timing variance can also be determined by observing distinctness of the vertical lines on the frame or measuring luminosity difference between adjacent sub pixels.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

What is claimed is:

1. A timing control method for a display comprising:
generating two gate timing signals with identical timing by a timing controller;
setting a timing variance by a timing modifier;
modifying said two gate timing signals with identical timing to a first gate timing signal and a second gate timing signal according to said timing variance and transferring to a gate driver by said timing modifier;
transmitting said first gate timing signal to a first gate line and said second gate timing signal to a second gate line by said gate driver; and
activating a charging process of a first sub pixel according to said first gate timing signal by said first gate line and a charging process of a second sub pixel according to said second gate timing signal by said second gate line;
wherein said first gate timing signal is defined by a first gate charging timing and said second gate timing signal is defined by a second gate charging timing, and said first gate charging timing is greater than said second gate charging timing.

2. The method according to claim 1, wherein said timing modifier comprises a control IC and a register.

3. The method according to claim 1, wherein said first gate charging timing is that average timing of said first gate charging timing and said second gate charging timing plus said timing variance.

4. The method according to claim 1, wherein said second gate charging timing is that average timing of said first gate charging timing and said second gate charging timing minus said timing variance.

5. The method according to claim 1, further comprising measuring luminosity difference between adjacent sub pixels to determine said timing variance.

6. The method according to claim 1, further comprising using capacitance on a data line to determine said timing variance.

7. A timing control method for a display comprising:
generating a plurality of gate timing signals with identical timing by a timing controller;
setting a timing variance by a timing modifier;
modifying said plurality of gate timing signals with identical timing to a plurality of odd gate timing signals and a plurality of even gate timing signals according to said timing variance and transferring to at least a gate driver by said timing modifier;
transmitting said plurality odd gate timing signals to a plurality of odd gate lines and said plurality of even gate timing signals to a plurality of even gate lines by said at least a gate driver; and
activating a charging process of a plurality of odd sub pixels according to said plurality of odd gate timing signals by said plurality of odd gate lines and a charging process of a plurality of even sub pixels according to said plurality of even gate timing signals by said plurality of even gate lines;
wherein said plurality of odd gate timing signals are defined by an odd gate charging timing and said plurality of even gate timing signals are defined by an even gate charging timing, and said odd gate charging timing is greater than said even gate charging timing.

8. The method according to claim 7, wherein said timing modifier comprises a control IC and a register.

9. The method according to claim 7, wherein said odd gate charging timing is that average timing of said odd gate charging timing and said even gate charging timing plus said timing variance.

10. The method according to claim 7, wherein said even gate charging timing is that average timing of said odd gate charging timing and said even gate charging timing minus said timing variance.

11. The method according to claim 7, further comprising measuring luminosity difference between adjacent sub pixels to determine said timing variance.

12. The method according to claim 7, further comprising using capacitance on a data line to determine said timing variance.
